(19) United States
(12) Patent Application Publication
(10) Pub. No.: US 2006/0172750 A1
(43) Pub. Date: Aug. 3, 2006

(54) Server apparatus, message

(75) Inventor: Takehiko Mizoguchi, Iruma-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/345,940

(22) Filed: Feb. 2, 2006

(30) Foreign Application Priority Data
Feb. 3, 2005 (JP) 2005-027175

(51) Int. Cl. H04Q 7/20

(52) U.S. Cl. 455/466

(57) ABSTRACT

The same message sent out from any terminal is intended to be sent to the other terminals as recipients securely and rationally. Server apparatus 1 automatically responds to a telephone call from any sender terminal 2, records the message, creates, registers and publishes a Web page to publish the message. Server apparatus 1 creates a SIP short message including an URL of the Web page, delivers the SIP short message to a plurality of recipient terminals 2 specified based on the information included in the message received from the sender terminal. When receiving a request from one of the recipient terminals, the server apparatus reads and sends the Web page to the requesting terminal.

### CROSS-REFERENCE TO RELATED APPLICATION

This application is based upon and claims the benefit of priority from the prior Japanese Patent Application No. 2005-027175, filed on Feb. 3, 2005, the entire contents of which are incorporated herein by reference.

### BACKGROUND OF THE INVENTION

1. Field of the Invention

The present invention relates to server apparatus connected to a plurality of terminals over a network to transmit the same message received from any one of the plurality of terminals to the other terminals as recipients, a message transmission system that comprises an IP network through which a server apparatus and a plurality of terminals compatible with IP softphones are connected, and a program used to perform the functions of the server apparatus.

2. Background Art

Generally, when the same message is transmitted simultaneously to a plurality of recipients, for example, when telephonic communication is performed among a plurality of terminals in a video conference system, it is required to prepare a good system environment by introducing a multi-point control unit and providing broad band lines. Use of an electronic bulletin board system as means for transmitting messages is not appropriate for transmitting urgent messages because it is impossible to predict when the recipient receives the message actually.

In order to take measures against traffic problems occurring in a network over which the same message is transmitted simultaneously to a plurality of recipients, a network system is known in which a department manager of a company having branches in all parts of a country sends information simultaneously to all the branches in each of which the information is transmitted from the branch manager to section chiefs concerned and subsection chiefs concerned in order of hierarchy. Thus, this network system is said to be effective as traffic measures because after the information is transmitted to the first recipient, or branch manager, it is transmitted only within the branch not over the wide area network.

Although this prior art is effective as the traffic measures, there is a possibility that when the recipient creates a hierarchy table indicative of hierarchical members and then sends the table to the next recipients, interruption will occurs during transmission of the information due to line troubles.

As described above, there are several problems with such prior art that in order to send a message simultaneously to a plurality of recipients, the system environment need be prepared, including provision of wide area lines, the time required from preparation for transmission of the message to its actual transmission is large and/or interruption can occur during the transmission of a message.

### SUMAMRY OF THE INVENTION

The subject of the present invention is to send the same message sent from a terminal in a network to a plurality of recipient terminals securely and rationally.

According to the invention of claim 1, a server apparatus is automatically responsive to a telephone call from any particular terminal to register a message included in the call. The server apparatus then creates a short message including link information accessible to the first-mentioned message and specifies a plurality of terminals as recipients of the short message among the first-mentioned plurality of terminals based on information on the message sent out by the particular terminal. The server apparatus then delivers the short message to the specified plurality of terminals. Then, responsive to a request from any second particular one of the specified plurality of terminals to which the short message was delivered, the server apparatus reads a message put in correspondence to link information included in the short message and sends it to the second particular terminal. The second particular terminal can then reproduce the message. That is, after simultaneously sending the specified plurality of terminals the short message to the effect that there was a message received, the server apparatus is capable of reading and sending a real message to any particular terminal of the specified plurality of terminals at the request of the particular terminal.

Thus, high practical advantageous effects are obtained. That is, when the message is sent simultaneously to the plurality of recipients, registration of the message can be separated from the reproduction of the message. Thus, preparation of a wide area lines as traffic measures on the network becomes unnecessary, and cost is reduced advantageously as well as a time required from the registration of the message to its reproduction is minimized. In addition, a situation in which interruption would otherwise occur during the transmission of the message is avoided. Thus, the message is transmitted to the plurality of recipients securely and rationally—high practical advantageous effects.

According to the invention of claim 3, advantageous effects similar to those produced by the invention of claim 1 are produced. In addition, the server apparatus, the plurality of terminals and the network may be compatible with an IP softphone. The short message may include the link information that indicates a storage location of the Web page. Responsive to a request from a third particular one of the specified plurality of terminals to which the server apparatus delivered the short message, the server apparatus sends the third particular terminal the Web page based on the link information included in the short message. Thus, the message can be sent rapidly to the third particular terminal. Since the possibility that requests for the Web page will be made by individual terminals at different times is high, the possibility of occurrence of high traffic load due to a simultaneous request for the Web page by many terminals is greatly reduced. Since the voice message publishing Web page includes link information accessible to the voice message file as requested, the voice message can be called many times as required. Also, the message can be called any times as requested.

In this case, the message publishing Web page may include link information accessible to the first-mentioned message as required and information specifying the first-mentioned terminal as the message sender and addresses of the message recipients (the invention of claim 4). Thus, it can be ascertained who the message sender and recipients are.

The message publishing Web page may include link information accessible to the first-mentioned message and a communication address to call the first-mentioned particular terminal as the message sender. The server apparatus is responsive to reception of a request from the third particular terminal to which the server apparatus delivered the Web page to call the message sender based on the communication address included in the Web page and then establish telephonic connection between the sender terminal and the third particular terminal (the invention of claim 5). For example, after reproducing the Web page message and listening to its contents, the recipient terminal is capable of making a return telephonic communication with the sender as required, and directly confirming the message content from the sender, thereby knowing its details. That is, this apparatus gives high convenience and rapid appropriate response.

The server apparatus message publishing Web page may include a list of plurality of link information items each accessible to a respective one of a plurality of messages. Responsive to a fourth specified one of the plurality of terminals which have received the short message specifying any particular one selected from among the list of the link information items included in the Web page, the server apparatus reads out a message put in correspondence to the link information item in the short message, and then sends the message to the fourth specified terminal (the invention of claim 6). That is, for example, the recipient terminal is capable of easily reproducing even messages sent thereto in the past, and if the messages have continuity or relevance in content, the contents of messages preceding and following any specified one can be compared—high practical advantageous effects.

The message may be added as a background sound to the message publishing Web page (the invention of claim 7). Thus, the recipient terminal is capable of automatically reproducing the Web message when the Web page is received without performing a-special operation on the Web page, thereby reducing a time required from the registration of the message to its reproduction.

According to the invention of claim 8, advantageous effects are produced which are similar to those produced by the invention of claim 1. In addition, a message recorded beforehand by any particular one of the terminals may be received and registered by the server apparatus. In this case, only a correctly recorded message will be finally registered in the server apparatus although the message may be rerecorded many times on the side of the particular terminal. Since the message recorded beforehand by the particular terminal is sent to the server apparatus, the telephonic communication time is reduced compared to a case in which a message is created while being sent in real time from the terminal to the server apparatus because there is a possibility that a wrong message may be created and some time may be taken for this correction. A long-time “busy” state of the lines concerned that would occur in this case is eliminated effectively by the invention of claim 8—high practical advantageous effects.

According to the invention of claim 9, advantageous effects similar to those produced by the invention of claim 1 are produced. In addition, in a state in which a relationship in correspondence between the plurality of terminals and a plurality of groups is changeably managed, a plurality of terminals belongs to a group to which the message sender is put in correspondence are specified as the recipients of the short message based on the information received from the message sender. Thus, the message recipients can be specified for each group. In addition, various types of flexible management are possible depending on how their relationship in correspondence is defined, and recipient terminals present over a plurality of groups can be specified as objects to be managed.

It is determined whether the group specified as the recipient of the short message is a formal one, and if so, the first-mentioned message is registered (the invention of claim 10). Thus, the message can be prevented from being sent to wrong recipients.

According to the invention of claim 11, advantageous effects similar to those produced by the invention of claim 1 are produced. In addition, a particular terminal may call the server apparatus and send information thereon and a message to the server apparatus. The server apparatus may register as a file the message received from the particular terminal, create a short message including link information accessible to the message file and then deliver the short message to selected ones of the plurality of terminals as specified recipients based on information from the particular terminal as the message sender. Any second particular one of the specified recipients may receive the short message delivered by the server apparatus, analyze the short message, automatically extract link information included in the short message, send a request to call the first-mentioned message to the server apparatus, and receive and reproduce a message file received from the server apparatus at the request. That is, the terminal can request the server apparatus to call the message directly after the short message is received, and the sender may send the message rapidly in a category in which the IP softphones are used usually.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram of the whole structure of a message transmission system;

FIG. 2 shows the structure of software provided on a server apparatus 1;

FIG. 3 illustrates the structure of a module of a VoIP softphone provided on each terminal 2;

FIG. 4 illustrates the organization of a company expressed as a hierarchy;

FIG. 5 illustrates a user data table D11 that stores and manages user SIP URIs as a part of a SPI URI management table D1 corresponding to the organization of FIG. 4;

FIG. 6 illustrates a group data table D12 that stores and manages group SIP URIs as a part of SPI URI management table D1;

FIG. 7 illustrates a user-to-group correspondence table D13 that stores and manages a relationship in correspondence between users and groups as a part of SPI URI management table D1;

FIG. 8 illustrates a data structure of a SIP short message;

FIG. 9 is a block diagram of server apparatus 1 in which the main basic components are shown;

FIG. 10 is a block diagram of a terminal 2 in which the main basic components are shown;

FIG. 11 is a time chart schematically illustrating the steps of operation of a message transmission system that sends the same voice message received from any terminal 2 of a plurality of terminals to the other;

FIG. 12 illustrates a voice message publishing Web page in which (A) shows an example of an HTML and (B) an example of a HTML source;

FIG. 13 is a flowchart indicative of creation of a voice message publishing Web page by Web page creation module 16;

FIG. 14 is a time chart of a modification involving an interaction to be performed between sender terminal 2 and server apparatus 1 in order that the server apparatus receives and registers a voice message file recorded beforehand by the sender terminal;

FIG. 15 illustrates another example of the voice message publishing Web page including link information to access the voice message file and a sender's SIP URI;

FIG. 16 illustrates a further example of the voice message publishing Web page including a plurality of link information items each accessible to a respective one of the voice message files as required; and

FIG. 17 illustrates a still further example of the Web page to which a voice message is added as a background sound.

### DETAILED DESCRIPTION OF THE INVENTION

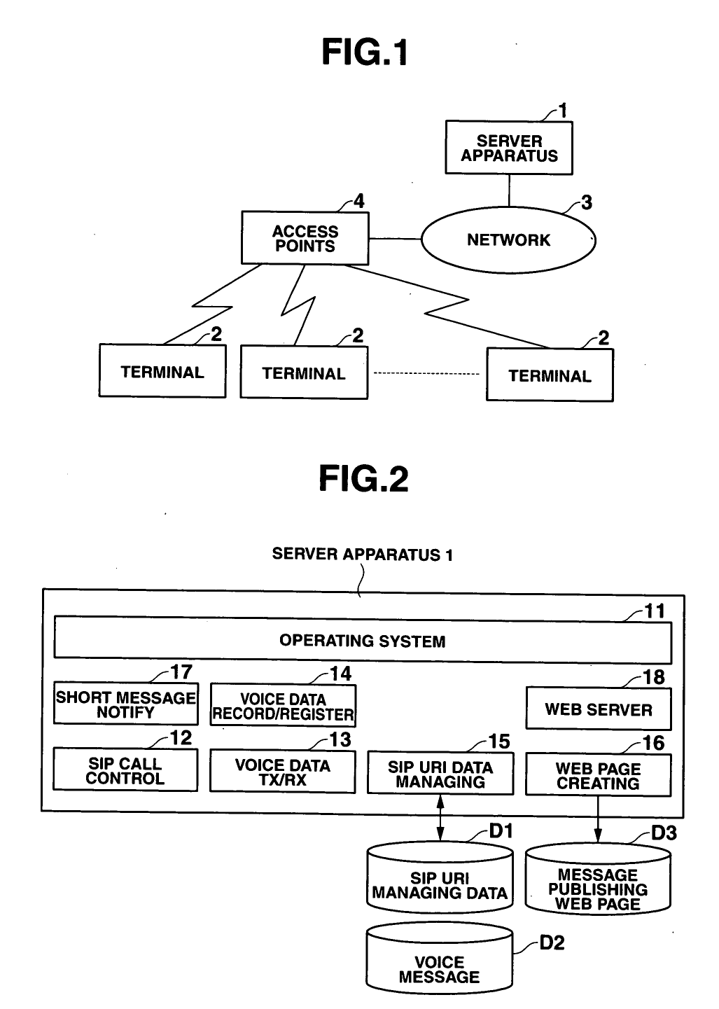

Referring to FIGS. 1-17, an embodiment of the present invention using a voice message will be described next. FIG. 1 is a block diagram of the whole structure of a message transmission system of the embodiment, which has a system environment in which server apparatus 1 that registers and manages voice messages and a plurality of terminals 2 compatible with VoIP (Voice over Internet Protocol) softphones are connected through an (IP) network 3. The same voice message sent out by any terminal 2 is sent the other terminals 2 as recipients under control of server apparatus 1. In this case, network 3 may be a local area network (LAN or intranet) constituted in the area of a company or a wide area network including a plurality of LANs connected. The LAN provided in the area of the company may be either a wireless LAN having a plurality of access points 4 or a wire LAN provided in the area of the company. Data digitized or packeted by HTTP (Hyper Text Transfer Protocol) using TCP/IP is sent and/or received between server apparatus 1 and respective terminals 2.

FIG. 2 illustrates the structure of software provided on server apparatus 1. Server apparatus 1 comprises operating system 11, SIP (Session Initiation Protocol) call control module 12 that establishes a voice transfer session on an IP network using SIP, and voice data transmission/reception module 13 that transmits/receives a voice message using a voice transfer session. In this embodiment, voice data recording/registering module 14 is provided which records and registers as a voice message file a voice message sent out by any terminal 2 and received by voice data transmission/reception module 13.

In this embodiment, server apparatus 1 further comprises SIP URI management module 15, Web page creation module 16, short message notification module 17, and Web sever module 18. SIP URI management module 15 specifies a plurality of terminals 2 belonging to each group as a recipient of a voice message by managing SIP URIs (Uniform Resource Identifiers), each allocated to a respective one of the plurality of terminals 2, for each group. Web page creation module 16 creates a file of a voice message received from any terminal 2, registers it, and creates a voice message publishing Web page with which the voice message file is linked.

After the voice message publishing Web page is created, short message notification module 17 creates a SIP short message including a URL (Uniform Resource Locator) of the message publishing Web page as link information accessible to the Web page as required, and delivers the SIP short message to terminals 2 specified as recipients. The short message is of a text-based short sentence type. When receiving a request from one of terminals 2 to which the SIP short message was delivered, Web server module 18 reads out a message publishing Web page put in correspondence to the link information of the SIP short message and sends it to the requesting terminal 2. Server apparatus 1 comprises SIP URL management data table D1, voice message file D2, and publishing Web page storage folder D3.

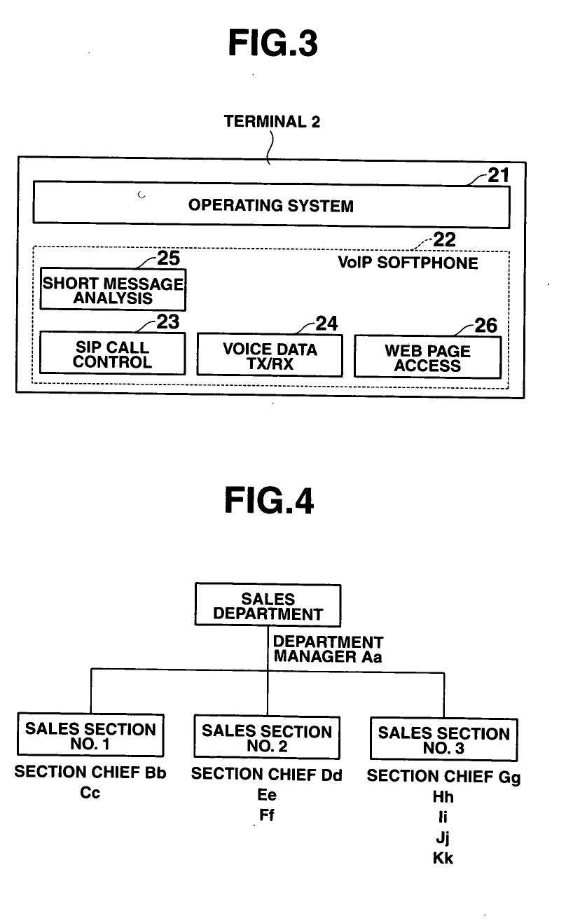

FIG. 3 illustrates the structure of a VoIP softphone module provided on each terminal 2. Each terminal 2 comprises operating system 21 and VoIP softphone 22. VoIP softphone 22 comprises SIP call control module 23 that establishes a voice transfer session on the IP network using the SIP, voice data transmission/reception module 24 that sends/receives a voice message in a voice transfer session, short message analysis module 25 that analyzes the content of a SIP short message received from server apparatus 1 and automatically extracts a URL of the message publishing Web page to which the voice message file is linked, and Web page access module 26 that accesses and requests server apparatus 1 to call the voice message publishing Web page based on the URL extracted by short message analysis module 25. While in the embodiment Web page access module 26 is illustrated as included in VoIP softphone 22, a browser included in terminal 2 may be started up to request server apparatus 1 to call the voice message publishing Web page.

FIG. 4 illustrates a corporation organization hierarchically. In this example, a sales department is illustrated as composed of lower-ranking sales sections Nos. 1, 2 and 3 each including a section chief and staffs.

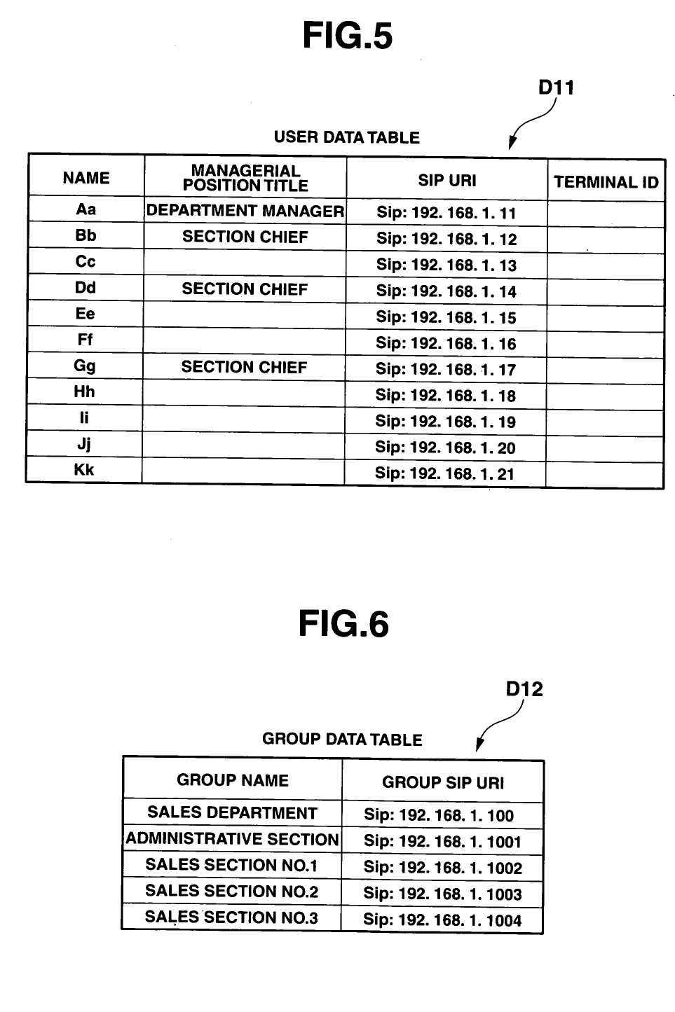

FIG. 5 illustrates user data table D11 that stores and manages SIP URIs allocated to the respective users or corporation employees as a part of SIP URI management data table D1 corresponding to the organization of FIG. 4.

User data table D11 stores and manages each user's name, managerial position title, SIP URI, and terminal ID. In this example, a corporation employee whose name is “Aa” has a managerial position of “department manager” and “sip: 192. 168. 1. 11” as the SIP URI. The “terminal ID” is used for user authentication.

FIG. 6 illustrates group data table D12 that stores and manages SIP URIs each allocated to a respective one of groups (including posts and managerial positions) as a part of SIP URI management data table D1.

Group data table D12 stores and manages the names and SIP URIs of the respective groups. In the example shown, the “group SIP URI” of a group name “sales department” is “sip: 192. 168. 1. 100”.

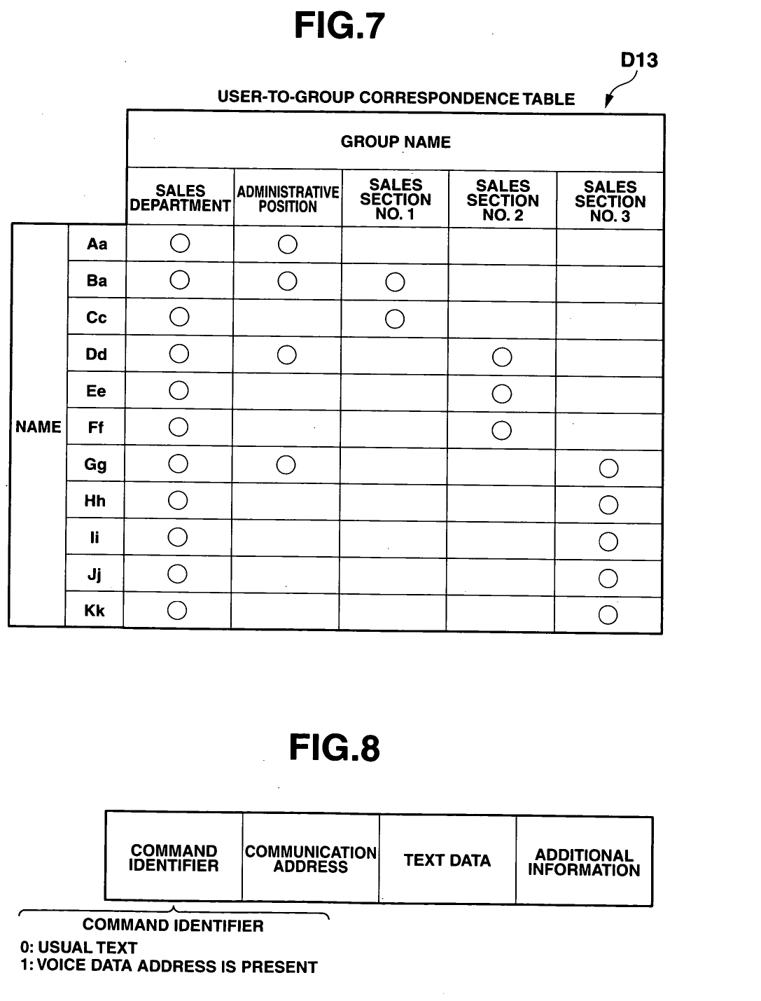

FIG. 7 illustrates user-to-group correspondence table D13 that manages a relationship in correspondence between each user and a respective one of groups as a part of SIP URI management data table D1. User-to-group correspondence table D13 has a matrix-like table in which respective users' names and respective group's names are disposed. In this table, a circle mark indicates a relationship in correspondence between a user and a group. For example, users Aa, Bb, Dd and Gg are shown as corresponding to a managerial position group, and users Bb and Cc as corresponding to sales section No. 1.

FIG. 8 illustrates a data structure of a SIP short message. This message comprises items “command identifier”, “communication address”, “text data”, and “additional information”. With a usual text, “0” is set to the “command identifier”. With a text containing a URL of a voice message publishing Web page, “1” is set to the “command identifier”. In this way, the SIP short message can be used as means for notifying of the URL of a voice message publishing Web page depending on the content of the “command identifier”.

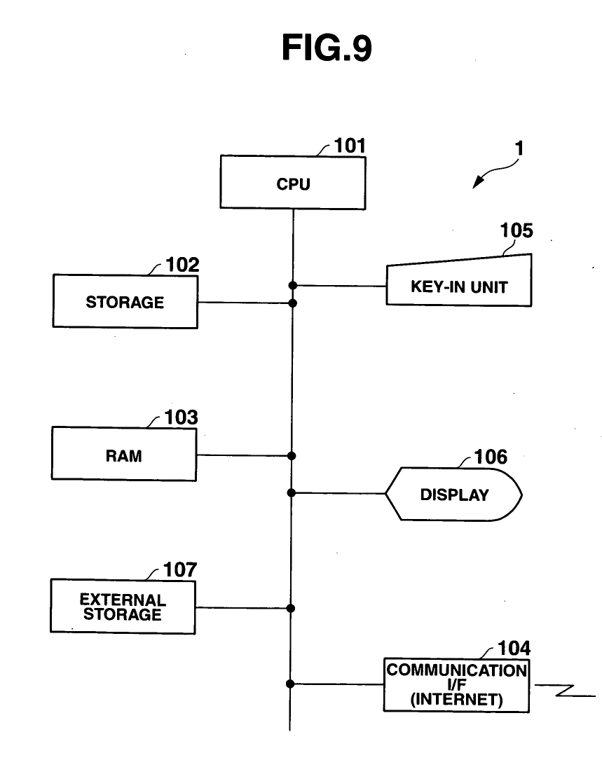

FIG. 9 is a block diagram of a basic structure of server apparatus 1. CPU 101 controls the whole server apparatus 1 in accordance with an operating system and various applications stored in storage 102. Storage 102 has a program area and a data area, and includes a magnetic memory, an optical memory, a semiconductor memory and drive systems for these memories. Storage 102 has stored in its program area operating system 11, SIP call control module 12, voice data transmission/reception module 13, voice data recording/registering module 14, SIP URI management module 15, Web page creating module 16, short message modification module 17, and Web server module 18. Storage 102 may be a fixed memory such as a hard disk, or a removable recording medium such as a CD-ROM or a DVD.

The programs and data stored in storage 102 are loaded or saved in RAM (for example, including a static RAM) 103 or data stored in RAM 103 is saved on storage 102. RAM 103 has a program execution area and a working area. CPU 101 is connected to communication I/F (or IP network communication interface) 104, key-in unit 105, display 106, and external storage 107 as peripheral input/output devices through bus lines. In accordance with the input/output programs, CPU 101 controls operation of these input/output devices. Key-in unit 105 comprises a keyboard, or a pointing device such as a mouse, thereby inputting character strain data, and/or various commands. Display 106 comprises a liquid crystal display with a touch panel thereon.

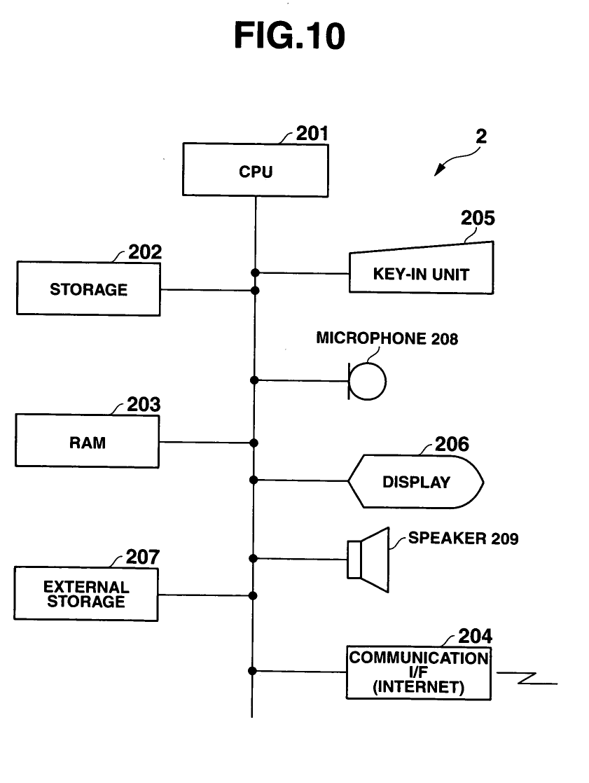

FIG. 10 is a block diagram of a basic structure of terminal 2. Terminal 2 is a PDA (Personal Digital Assistance) compatible with a VoIP softphone and like server apparatus 1, comprises CPU 201, storage 202, RAM 203, communication I/F 204, key-in unit 205, display 206, external storage 207, microphone 208 and a speaker 209 which compose a telephone function. Storage 202 has stored operating system 21, VoIP softphone 22, SIP call control module 23, voice data transmission/reception module 24, short message analysis module 25, and Web page access module 26. Display 206 comprises a liquid crystal display with a touch panel thereon.

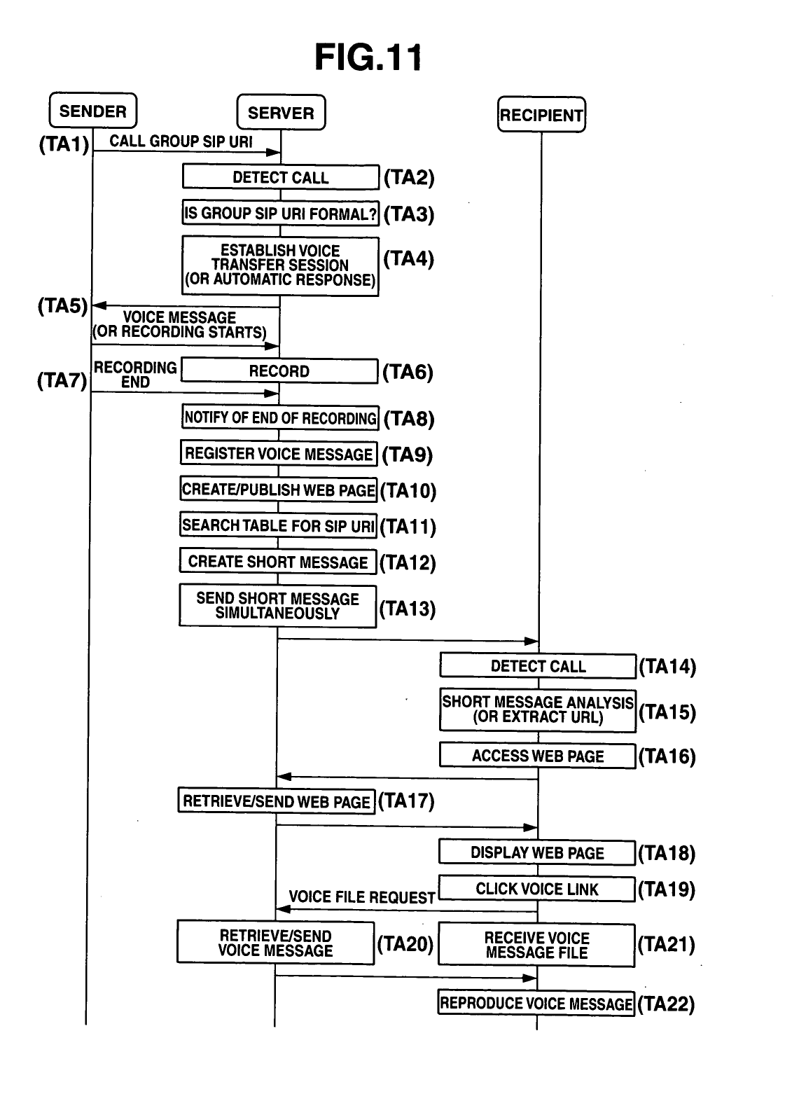

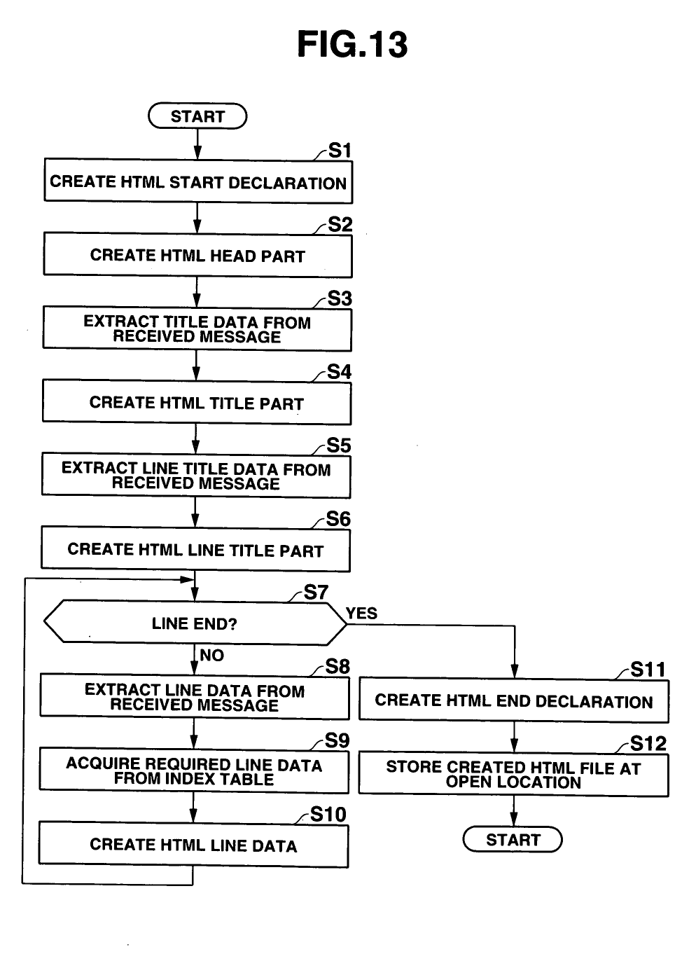

Then, operation of the message transmission system of this embodiment will be described with reference to a time chart of FIG. 11 and a flowchart of FIG. 13. The respective functions described in the time chart and the flowchart are stored in the form of program codes readable by computer and sequentially performed in accordance with the program codes. The message transmission system can sequentially perform operation in accordance with programs received externally via a transmission medium (not shown). The operation of the system unique to this embodiment can be performed using the programs/data recorded on the recoding media or received externally via the transmission media.

FIG. 11 is a time chart schematically illustrating operation of the message transmission system that sends a voice message received from any terminal 2 to the other terminals 2.

In FIG. 11, (TA1)-(TA22) show the steps of operation to be performed among sender terminal 2, server apparatus 1, and recipient terminal 2 when sender terminal 2 sends the same voice message to a plurality of recipient terminals 2 under control of server apparatus 1.

First, when message sender terminal 2 (for example, of sales department manager Aa) specifies and calls a group SIP URI (for example, of sales section No. 1) as a recipient (TA1), server 1 detects the call using its SIP call control module 12 (TA2), searches for group data table D12 based on group SIP URI specified as the recipient, then determines whether a formal group is specified as a recipient, and if so, registers the group (TA3). In this case, since the group SIP URI (of sales section No. 1) is defined on group data table D12, server 1 determines that it is a normal group and establishes a voice transfer session (or an automatic response) (TA4).

In a state where the voice transfer session is established and when in sender terminal 2 voice data transmission/reception module 24 is started up and sends inputted voice data to server apparatus 1 to record the voice message (TA5), and server apparatus 1 starts to record the voice data by starting up recording/registering module 14 (TA6). When sender terminal 2 performs an on-hook or line-cutting operation after the whole message has been inputted, server apparatus 1 completes the voice transmission session or recording (TA7).

Server apparatus 1 then responds to detection of the on-hook or line-cutting operation of sender terminal 2 by SIP call control module 12 (TA8), to read out the recorded voice message, and then registers it as a voice file in voice message file D2 (TA9). After this registration, server apparatus 1 starts up Web page creation module 16, thereby creating a voice message publishing Web page to be linked with the voice message file, and then registers and publishes it in a publishing Web page storage folder D3 of Web server module 18 (TA10).

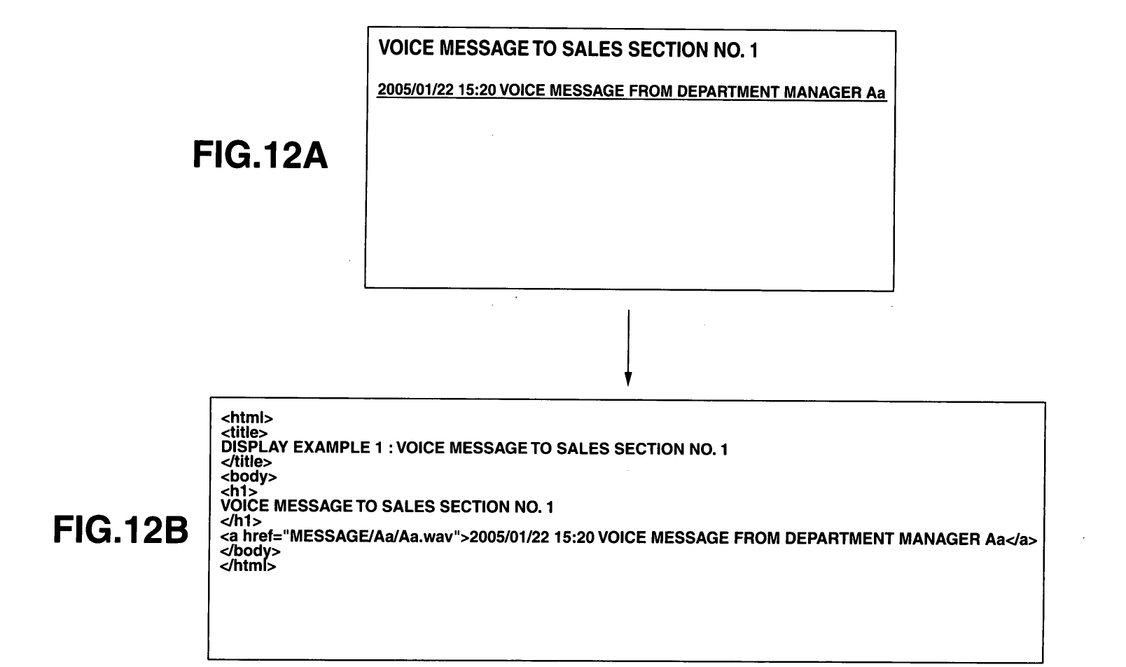

FIG. 12 illustrates the voice message publishing Web page that includes link information indicative of the location of the voice message file in a HTML (Hyper Text Markup Language) sentence in which (A) denotes an example of HTML and (B) an example of a HTML source. This message publishing Web page is created in accordance with a flowchart of FIG. 13 to be described later further, and has a title “Voice message to sales section No. 1” and a body including link information on a voice message file “2005/01/22 15:20 a voice message from department manager Aa”. Data on a part of the title “sales section No. 1” is obtained by searching for group data table D12 based on received data (including group SIP URI) from sender terminal 2. Also, the link information “2005/01/22 15:20 department manager Aa” is obtained based on the data received from sender terminal 2.

FIG. 13 is a flowchart indicative of creation of the voice message publishing Web page by Web page creation module 16.

First, Web page creation module 16 creates a HTML start declaration (step S1), creates a header (step S2), extracts title data from the data received from sender terminal 2 (step S3), and then creates a HTML title (step S4). Web page creation module 16 extracts line title data from the received data (step S5), and then creates the HTML line title (step S6). Then, Web page creation module 16 checks whether the HTML line has ended (step S7), and if not, extracts line data from the received data (step S8). Web page creation module 16 then acquires line data from an index table (not shown) as required (step S9), and then creates the HTML line data (step S10). Thus, when creation of the HTML file is completed, Web page creation module 16 creates a declaration that the process has been completed (step S11), and then stores the created HTML file at an open location (step S12).

After the voice message publishing Web page is recorded and published, server apparatus 1 starts up SIP URI management module 15, searches for user-to-group correspondence table D3 based on data (on group SIP URI) received from sender terminal 2 and then acquires user SIP URI belonging to the appropriate group (TA11). If the group SIP URI specified by the sender terminal of department manager Aa is “sales section No. 1”, server apparatus 1 acquires the user SIP URIs put in correspondence to users Bb and Cc and specifies them as recipients of the voice message.

If the group SIP URI is “managerial position”, server apparatus acquires respective user SIP URIs put in correspondence to users Aa, Bb, Dd and Gg and then specifies them as the recipients of the voice message. Then, short message notification module 17 is started up and then creates a SIP short message having a URL of the voice message publishing Web page its body (TA12). Server apparatus 1 then simultaneously sends the SIP short message to the user SIP URIs specified as the recipients (TA13).

When recipient terminal 2 detects the arrival of the SIP short message from server apparatus 1, using SIP call control module 23 thereof (TA14), short message analysis module 25 is started up and analyzes a “command identifier” of the SIP short message, thereby determining whether the message includes a usual text or the URL of a voice message publishing Web page. If the message includes the Web page URL, the analysis module 25 automatically extracts the URL of the Web page included in the SIP short message (TA15). Then, Web page access module 26 is started up and requests server apparatus 1 to call the Web page based on the extracted URL (TA16). Then, server apparatus 1 retrieves an appropriate voice message publishing Web page and then sends it to requesting recipient terminal 2 (TA17).

In this case, recipient terminal 2 receives the voice message publishing Web page received from server apparatus 1 and displays it through the browser on the display (TA18). When the user clicks link information for the voice message pasted on the Web page picture with the cursor, the link information is extracted from the Web page and the recipient terminal 2 sends server apparatus 1 a request to call the voice message file in accordance with the link information (TA19).

When receiving the request from recipient terminal 2, server apparatus 1 retrieves an appropriate voice message file and then sends it to the requesting recipient terminal 2 (TA20). In this case, downloading the voice message file is performed in a non-streaming transfer using HTTP. Recipient terminal 2 receives the voice message file sent by server apparatus 1 (TA21) and starts up reproduction of the voice message (TA22). After sending the SIP short message simultaneously to the plurality of recipient terminals and each time server apparatus 1 receives a request from another recipient terminal 2, server apparatus 2 responds to the request, thereby calling and sending the voice message file to that recipient terminal 2.

As described above, in the voice message transmission system of this embodiment, server apparatus 1 automatically responds to a telephone call from any sender terminal 2 and records its voice message. The server apparatus creates and then registers a Web page to publish the voice message. The server apparatus then publishes the Web page, creates a SIP short message including the Web page URL, and then delivers the SIP short message to a plurality of recipient terminals 2 specified based on the information from the sender terminal 2. When receiving a request from the recipient terminal 2, server apparatus 1 calls and sends the Web page to the recipient terminal 2. That is, after notifying the plurality of recipients simultaneously of the SIP short message to the effect that the voice message was received, the server apparatus can send a real voice message to any one of the recipient terminals at its request.

Thus, when the voice message is sent simultaneously to the plurality of recipient terminals, registration of the voice message is separable from the reproduction of the voice message and hence no broad band lines need be prepared for the traffic measures on the IP network, thereby reducing the cost advantageously. In addition, a time required from the registration of the voice message to its reproduction is minimized and a situation in which interruption occurs during transmission of the message is avoided. Thus, the voice message can be sent to the plurality of recipient terminals rapidly, securely and rationally—practical advantageous effects. In this case, the voice message is sent from the server apparatus to the Since the possibility that requests for the Web page will be made by individual terminals at different times is high, the possibility of occurrence of high traffic load due to a simultaneous request for the Web page by many terminals is greatly reduced. Since the voice message publishing Web page includes link information accessible to the voice message file as requested, the voice message can be called many times as required. Since the Web page includes information on the sender and recipients of the voice message, the sender and the recipients who send and receive the message can be identified.

Server apparatus 1 specifies as recipients of the SIP short message a plurality of users belonging to a group put in correspondence to the sender based on the information from the voice message sender in a state in which the relationship in correspondence between the respective users and groups is managed. Thus, the voice message recipients can be specified for each group. Various types of combinations of transmission and reception of the voice message are usable depending on how to determine the relationship in correspondence between users and groups. Thus, message recipients can be specified through a plurality of groups. Server apparatus 1 determines in the registration of the voice message whether the group specified as the recipient of the voice message is a formal one, and if so, registers the voice message. Thus, delivery of the voice message to wrong terminals excluding ones of interest is prevented.

While in the embodiment server apparatus 1 is illustrated as automatically responding to a call from sender terminal 2, thereby establishing a voice transfer session; receiving a voice message from sender terminal 2; starting to record the message; and then responding to the detection of termination of the message recording, thereby registering the message, the server apparatus may receive and register the voice message file recorded beforehand by sender terminal 2.

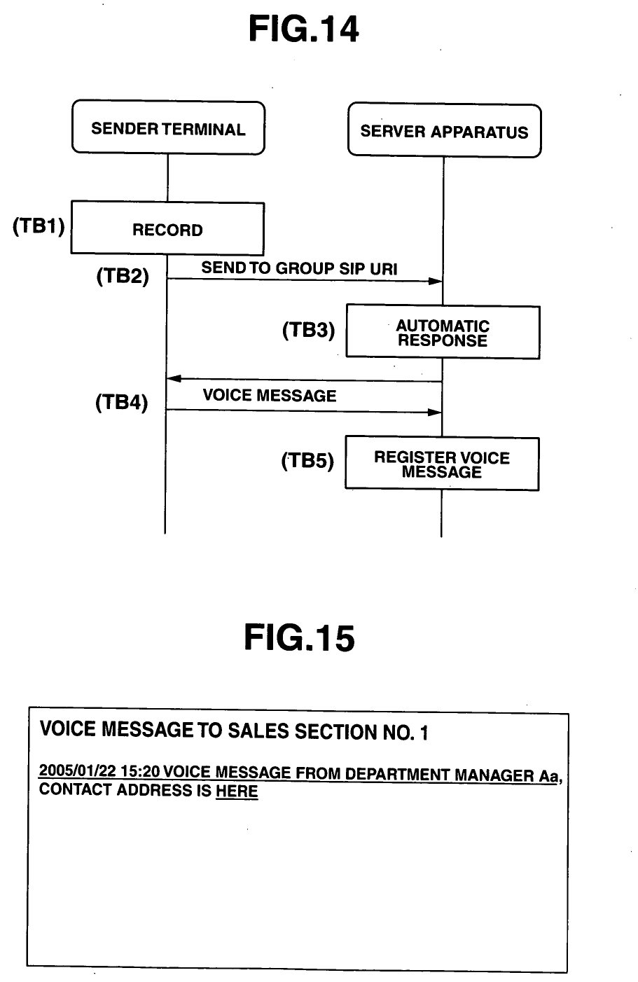

FIG. 14 is a time chart schematically illustrating this process. In FIG. 14, (TB1)-(TB5) illustrate the steps of an interaction to be performed between sender terminal 2 of the voice message and server apparatus 1 in order that the server apparatus acquires and registers the voice message sent out from sender terminal 2.

First, voice message sender terminal 2 inputs a message in voice and records it as a voice message file (TB1). Then, sender terminal 2 specifies a group SIP URI (for example, of sales section No. 1) as a recipient and calls the server apparatus (TB2), server apparatus 1 detects the arrival of the call with SIP call control module 12 thereof and performs a voice transfer session (or automatic response) (TB3). When sender terminal 2 then reads out the recorded voice message file and sends it to server apparatus 1 in accordance with HTTP (TB4), server apparatus 1 registers the voice message file (TB5). Like the above embodiment, server apparatus 1 creates a voice message publishing Web page with which the voice message file is linked, registers it in publishing Web page storage folder D3 of Web server module 18, publishes it, creates a SIP short message, and sends it simultaneously to the plurality of recipient terminals 2.

As described above, the server apparatus receives and registers the voice message file recorded or rerecorded beforehand by sender terminal 2. Thus, a long-time “busy” state of the network lines that would otherwise be caused by real-time recording or rerecording of the message to be performed from the sender terminal to the server apparatus over the network lines is eliminated, which leads to reduction of the telephonic communication time. Sender terminal 2 may record the voice message file and transfer this file using FTP (File Transfer Protocol) instead of recording and HTTP transfer of the voice message file.

While in the embodiment the voice message publishing Web page is illustrated as including link information accessible to the voice message file as requested, the Web page may additionally include communication addresses (SIP URIs) to call voice message sender terminals 2 in addition to the link information. In this case, when creating the voice message publishing Web page, server apparatus 1 is required to incorporate into the Web page the sender's SIP URI received in the registration of the voice message.

FIG. 15 illustrates link information to access the voice message file and an example of a voice message publishing Web page including the sender's SIP URI. The Web page includes an indication “Your contact address is here” after the link information. If you click “here” of the indication, sender terminal 2 is called based on its SIP URI.

By including the sender's SIP URI in the voice message publishing Web page as described above, recipient terminal 2 that has received this Web page can reproduce and listen to the contents of the message and then perform telephonic communication with the sender by return as required, and can directly ascertain the contents of the message from the sender and know the details of the message. That is, high convenience and rapid handling are achieved.

While in the embodiment the voice message publishing Web page is illustrated as including only link information to access the voice message file recorded and registered this time, a list of plurality of link information items each accessible to a respective one of a plurality of voice messages as requested may be displayed.

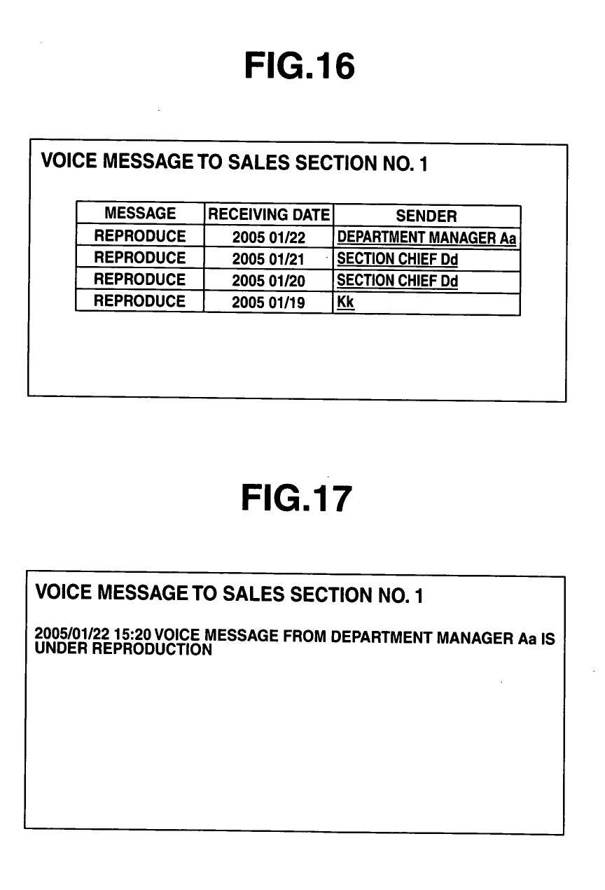

FIG. 16 shows an example of a voice message publishing Web page including a plurality of link information items each accessible to a respective one of a plurality of voice message files.

Following a link information item of the voice message file recorded and registered this time, link information items on the voice message files recorded and registered in the past are disposed and displayed on the Wave page in order of registration. That is, following the voice message recorded and registered this time “sender: department manager Aa”, voice messages in the past “sending date: 2005/01/21/, sender: section chief Dd”, “sending date: 2005/01/20/, sender: section chief, Dd”, and “sending date: 2005/01/19/, sender: Kk” are indicated as a list. If recipient terminal 2 receives the Web page and clicks any link information item among the list of the Web page, the server apparatus responds to this manipulation, reads and sends the recipient terminal a corresponding voice message file. The recipient terminal can reproduce any past voice message sent thereto. If a series of messages received have continuity in content, the contents of the received messages preceding and following any particular message can be compared—high practical advantageous effects.

While in the embodiment link information items to access the voice message files are illustrated as pasted to the voice message publishing Web page, a voice messages may be added as corresponding background sounds to the Web page.

FIG. 17 shows an example of the Web page to which a voice message is added as the background sound with a comment to the effect that the voice message is under reproduction on the Web page.

As described above, by adding the voice message as the background sound to the message publishing Web page, recipient terminal 2 can automatically reproduce the voice message when the Web page is received without performing any special operation on the Web page, and further reduce a time required from the registration of the voice message to its reproduction.

Furthermore, recipient terminal 2 may request server apparatus 1 to ascertain the arrival of a new received message at any particular time, for example, at a time when the user performs some operation on his or her terminal or turns on its power source. Since this ascertainment is maintained effective even when reception of the SIP short message then fails or the power source then goes dead.

While in the embodiment the voice message is illustrated as the message, an image message may be used instead of the voice message or both the voice and image messages may be used instead. The image messages are not limited to moving-image messages, but may be still messages or both the moving and still image messages.

While each terminal 2 is illustrated as a PDA compatible with VoIP softphone, it may be a note-type personal computer compatible with the IP softphone.

Server apparatus 1 is not limited to one of a stand-alone type, but may be a dispersion type system whose components are divided physically so as to be housed into two or more housing parts and which sends/receives data via wire transmission paths such as communications lines or cables or via wireless transmission paths for radio waves, microwaves or infrared rays of light.

A computer may be supplied with recording media (such as, for example, CD-ROMs, flexible disks, RAM cards) that have recorded program codes to cause the computer to perform the above mentioned various functions. The computer-readable media may be coded with a program that has the functions of automatically responding to a telephone call from any terminal, and registering and managing the message, creating a short message including link information accessible to the message, specifying a plurality of terminals as recipients of the short message based on the information from the message sender, delivering the short message to the specified plurality of terminals, and in response to a request from any one of the specified terminals to which the short message was delivered, reading out a message put in correspondence to the link information of the short message and sending the message to the requesting terminal.

What is claimed is:

1. A server apparatus connected along with a plurality of terminals through a network so as to send the same message sent out by any particular one of the terminals to selected ones of the plurality of terminals, the apparatus comprising:
message registering means, automatically responsive to a telephone call from the particular terminal, for registering and managing a message included in the call;
message creating means for creating a short message including link information accessible to the first-mentioned message;
specifying means for specifying a plurality of terminals as recipients of the short message among the first-mentioned plurality of terminals based on information on the message sent out by the particular terminal;
delivering means for delivering the short message to the plurality of terminals specified by the specifying means; and
sending means, responsive to a request from any second particular one of the specified plurality of terminals to which the short message was delivered, for reading a message put in correspondence to link information included in the short message and for sending the read message to the second particular terminal.

2. The server apparatus of claim 1, wherein the first-mentioned message is a voice message, an image message or a voice and image message.

3. The server apparatus of claim 1, wherein the server apparatus, the plurality of terminals and the network are compatible with an IP softphone, and further comprising:
Web page creating means for creating a Web page to publish the first-mentioned message received from the first-mentioned particular terminal and registered by the server apparatus; and wherein:
the link information indicates a storage location of the Web page; and responsive to reception of a request from a third particular one of the specified plurality of terminals to which the server apparatus delivered the short message, the server apparatus sends the third particular terminal the Web page based on the link information included in the short message.

4. The server apparatus of claim 3, wherein the message publishing Web page includes link information accessible to the first-mentioned message as required and information specifying the first-mentioned terminal as the message sender and addresses of the message recipients.

5. The server apparatus of claim 3, wherein the message publishing Web page includes link information accessible to the first-mentioned message and a communication address to call the first-mentioned particular terminal as the message sender; and wherein:
the server apparatus is responsive to reception of a request from the third particular terminal to which the server apparatus delivered the Web page to call the message sender based on the communication address included in the Web page and then establishes telephonic connection between the sender terminal and the third particular terminal.

6. The server apparatus of claim 3, wherein the message publishing Web page includes a list of plurality of link information items each accessible to a respective one of a plurality of messages; and
responsive to a fourth specified one of the plurality of terminals which have received the short message specifying any particular one selected from among the list of the link information items included in the Web page, the server apparatus reads out a message put in correspondence to the link information item in the short message, and then sends the message to the fourth specified terminal.

7. The server apparatus of claim 3, wherein the Web page creating means adds a background message to the message publishing Web page.

8. The server apparatus of claim 1, wherein the message registering means receives and registers a message recorded beforehand by any one of the plurality of terminals.

9. The server apparatus of claim 1, further comprising group managing means for managing a relationship in correspondence between the plurality of terminals and a plurality of groups; and wherein:
each of the plurality of terminals belongs to a least one selected one of the plurality of terminals and the specifying means specifies as recipients of the short message the other ones of the plurality of terminals belonging to the group to which the message sender belongs based on information sent out from the message sender.

10. The server apparatus of claim 9, wherein the message registering means is responsive to a telephone call from any particular one of the plurality of terminals to determine whether the specified group to which the short-message recipients belong is a formal one, and if so, registers the short message.

11. A message transmission system in which a plurality of terminals compatible with IP softphones and a server apparatus that registers and manages messages are connected through an IP network, thereby transmitting the same message sent out from any particular one of the plurality of terminals to selected ones of the plurality of terminals as recipients excluding the particular terminal, wherein:
the particular terminal calls the server apparatus and sends information thereon and a message to the server apparatus;
after registering as a file the message received from the particular terminal, the server apparatus creates a short message including link information accessible to the message file and then delivers the short message to selected ones of the plurality of terminals as specified recipients based on information from the particular terminal as the message sender; and
after receiving the short message delivered by the server apparatus, any particular one of the specified recipients analyzes the short message, automatically extracts link information included in the short message, sends a request to call the first-mentioned message to the server apparatus, and receives and reproduces a message file received from the server apparatus at the request.

12. A computer-readable program that causes a computer to perform the functions of:
automatically responsive to a telephone call from a particular one of a plurality of terminals, registering and managing a message included in the call;
creating a short message including link information accessible to the first-mentioned message;
specifying a plurality of terminals as recipients of the short message among the first-mentioned plurality of terminals based on information on the message sent out by the particular terminal;
delivering the short message to the specified plurality of terminals; and
responsive to a request from any second particular one of the specified plurality of terminals to which the short message was delivered, reading a message put in correspondence to link information included in the short message and then sending the read message to the second particular terminal.
